(19) United States
(12) Patent Application Publication
(10) Pub. No.: US 2006/0168886 A1
(43) Pub. Date: Aug. 3, 2006

(54) Bench watering system

(76) Inventors: Todd McNulty, Northglenn, CO (US); Evan Sharples, Northglenn, CO (US); Michael Porter, Northglenn, CO (US)

Correspondence Address: GLENN L. WEBB, P.O BOX 951, CONIFER, CO, 80433, US

(21) Appl. No.: 10/613,770

(22) Filed: Jul. 2, 2003

(51) Int. Cl. A01G 25/00

(52) U.S. Cl. 47/81

(57) ABSTRACT

A system for providing self watering of plants on a display structure. The system includes a top on the display structure having sides and a bottom forming a water tight structure. A reservoir having a series of perforations forming a honeycomb pattern is placed in the top. A water supply pipe having a series of spaced perforations extends along one side of the top. A capillary mat is placed over the reservoir for plants to sit upon. In use, water is supplied through the perforations of the water supply pipe evenly across the reservoir. The capillary mat absorbs the water until the mat is saturated. This water is absorbed by the roots of the plants in containers on the mat as needed.

### FIELD OF THE INVENTION

This invention relates to the field of watering systems for plants, and particularly to the field of a bench or table top watering system.

### BACKGROUND OF THE INVENTION

The display of plants requires frequent watering of these plants to maintain their appearance. Often, it is difficult to maintain a regular schedule of watering due to staffing, shifts, uneven temperature and humidity fluctuations and other problems. Further, hand watering of the plants is often uneven, not only in time but in amount as well. This can lead to deterioration of the plants. Automated watering systems have been used in the past, but these tend to be expensive and complicated to operate.

Typical watering practices for display plants tends to be surface watering. Many plants prefer bottom watering as opposed to surface watering. The use of surface watering on such plants may not allow the appropriate water to the root structure of such plants. Also, some plants on the same display require less water than others.

Self watering planters have been developed to address these issues. However, the typical self watering planter is designed for an individual plant, thus requiring special planters for each individual plant. This can be quite expensive for large displays. Also, this limits the choices available for the individual plants in regard to color, size, shape, etc. for the displays. The self watering planters must also be connected to a water supply, thus increasing the expense and limiting the arrangement of the display.

A particular type of self watering planter has been developed to overcome some of these problems. This type of self watering planter is referred to as a capillary system. A capillary material, such as a spandex material, polyethylene or other materials that will wick moisture is placed on a table, bench or even in the bottom of a plant container. The end of the capillary material is dipped into a water trough or water supply to allow water to be wicked up next to the plant roots to supply water to the plant. Examples of these systems are disclosed in U.S. Pat. Nos. 5,189,834; 5,673,511; 5,839,659; and 6,079,156.

A problem with systems such as these is that the water is wicked up unevenly. The water is immediately absorbed through capillary action by the material nearest the water supply, and less water is available at locations distant from the water supply. This leads to uneven water distribution among plants located on the capillary mat.

Thus a need exists for a plant watering system for providing even distribution of water to plants on a display table or bench.

### SUMMARY OF THE INVENTION

The present invention provides solutions to these and other needs by providing a self watering system for display structures for plants. The system of the present invention provides a watering system for an attractive display for retail and wholesale sales of plants. The system of a preferred embodiment of the present invention allows plants to self water and maintain themselves without the intervention of workers.

In a preferred embodiment of the present invention, the system provides a display structure that self waters plants without the need of special plant containers. Ordinary plant containers of any size, shape and color may be used as long as they have a typical drain hole on the bottom or sides of the container. The plants may be moved or replaced without concern.

The system of a preferred embodiment provides a self watering system that is clean and attractive and does not detract from the display of the plants. The self watering system is hidden and not visible to customers.

The system of a preferred embodiment is simple and does not require expensive controls or equipment that would require constant maintenance. Once the system is setup, it is simple to maintain and only occasionally requires maintenance.

The system of the preferred embodiment includes a watertight top on a display structure. A reservoir having a series of perforations forming a honeycomb pattern for holding water is placed in the top. A water supply pipe extends along one side of the top with perforations for providing water evenly across the reservoir. A capillary mat is placed over the reservoir for absorbing water from the reservoir. Plants are then placed on the capillary mat. The potting media absorbs water from the capillary mat as necessary and supplies the water to the plants root system.

Water is supplied evenly to all parts of the capillary mat so that plants are able to self water without regard to their location on the display structure. The reservoir is able to support the capillary mat and plants without the capillary mat sitting in the water itself.

These and other features of the present invention are evident from the ensuing description of preferred embodiments and from the drawings.

### BRIEF DESCRIPTION OF THE DRAWINGS

FIG. 1 illustrates a series of display tables for plants that use the self watering system of a preferred embodiment of the present invention.

FIG. 2 illustrates the reservoir of the embodiment of FIG. 1.

FIG. 3 is a detailed view of the reservoir of FIG. 2.

FIG. 4 is a cutaway view of the system of FIGS. 1-3.

### DETAILED DESCRIPTION OF PREFERRED EMBODIMENTS

The present invention provides a system for providing an attractive display for plants that also allows for the watering of plants in a clean environment through capillary action. It is to be expressly understood that the descriptive embodiments set forth herein are intended for explanatory purposes and is not intended to unduly limit the scope of the claimed inventions. Other embodiments and applications not described herein are considered to be within the scope of the invention. It is also to be expressly understood that while specific embodiments for the components of the system are discussed, other equivalents to these embodiments that perform substantially similar functions are within the scope of the claimed inventions.

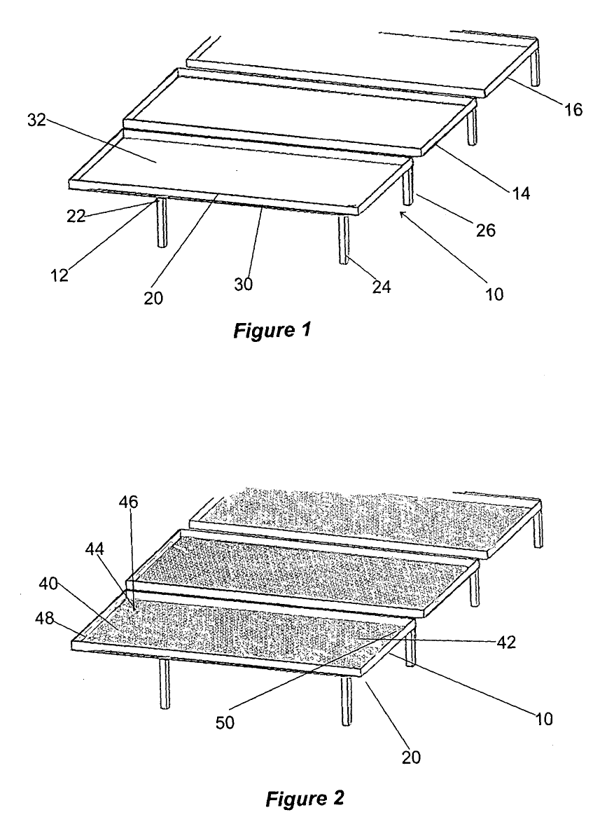

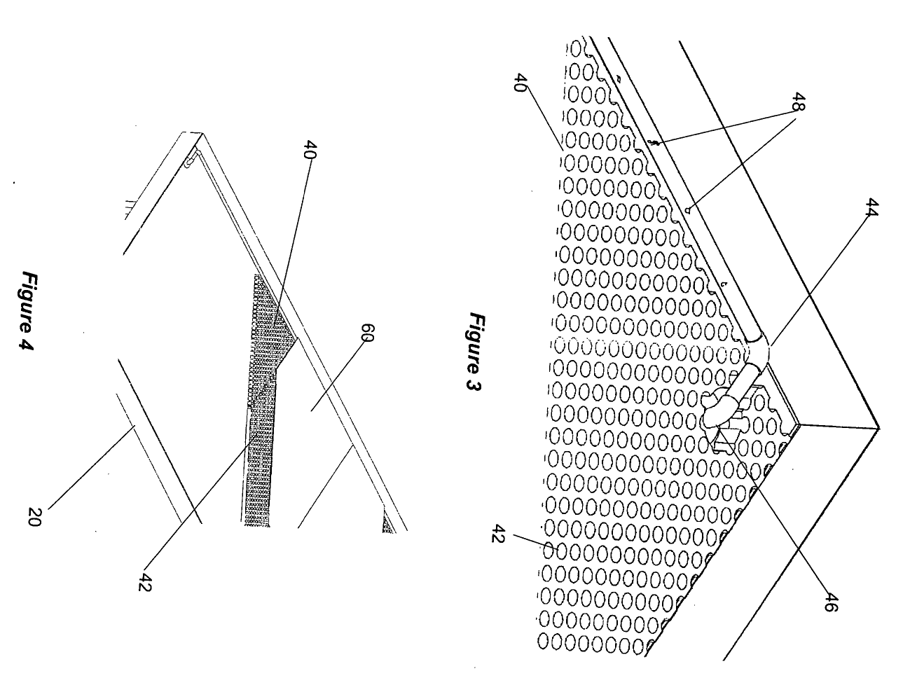

A preferred embodiment of the present invention is illustrated in FIGS. 1-4. The watering system 10 is incorporated into a table or bench 12. The table 12 can be used as a stand alone display or connected to other tables, such as tables 14, 16. Also, additional tables can be interconnected end to end as well to create a level or tiered display.

The table 12 includes top 20 with an under carriage of legs 22, 24, 26, 28 to support the top. It is to be expressly understood that other shapes, sizes and configurations of tables, benches and tops can be used under the presently claimed invention. The top 20 includes a perimeter rail 30 that is watertight at the corners. The top 20 also includes a bottom 32 that is connected to the perimeter rail in a watertight connection. In this preferred embodiment, the top 20 is formed from aluminum with welded connections, but other materials and connections could be used as well, including but not limited to plastic, wood, or any other suitable material.

Reservoir 40, shown in FIGS. 2, 3 and 4 is placed on the bottom surface 32 of the top 20 between the perimeter rails 30. The reservoir 40 includes a perforated material formed of a honeycomb material, such as plastic, rubber, metallic or any other suitable material. The perforations 42 or honeycombs are evenly spaced across the top of the table.

It is to be expressly understood that the reservoir could also include other water containing mechanisms, such as horizontal channels, or even a sponge like material that is firm enough to support the capillary mat and plants contained thereon.

Supply pipe 44 extends across one side of the top 20 and is connected 46 through either the undersurface, side or over the rails 30 of the top to a water source. The supply pipe 44 includes a series of evenly spaced perforations 48. In this preferred embodiment, the top 20 also includes stand pipes 50 in opposing comers of the top 20 to prevent overfilling of the top 20.

The water supply pipe 42 can be connected to a water hose or plumbed to a permanent connection. The water supply pipe 42 can also be interconnected to water supply pipes on additional display tables as well.

Capillary mat 60 is placed over the honeycomb reservoir 40, as shown in FIG. 4. In the preferred embodiment, capillary mat is formed from a woven barrier fabric that will wick water and other fluids evenly upward from the honeycomb reservoir. It is to be expressly understood that other materials may be used as well, including spandex, polyethylene and other woven or materials that are suitable for wicking water.

In use, plants in containers filled with potting media, soil or other organic bases are placed on the capillary mat 50. Water is provided through the supply pipe 42. The water flows through the perforations 48 evenly into the reservoir 40 until the reservoir is filled with water. The capillary mat absorbs the water until it is saturated. The potting media in the plant container absorbs the water through existing drain holes in the plant container to make it available to plant roots. This constant source of water allows the plant to self water for days without the need to refill the reservoir or the need for special attention as normal plant watering requires.

The reservoir 40 provides water uniformly across the capillary mat so that all plants on the top 20 are able to have a uniform source of water. The reservoir also keeps the capillary mat from sitting directly in the water.

The reservoir may be filled either until water spills into the stand pipes, a preset amount of time or a timer or fill control mechanism may be used to provide automatic watering.

The use of the system of the present invention enables the plants to be self watering in an attractive and clean environment. There is no need for special containers or special equipment beyond the system as discussed above. The system allows plants to be displayed in an attractive manner in a healthy environment without the constant intervention of workers.

It is to be expressly understood that other embodiments of the present invention are included in the claims. The above explanatory embodiments are provided for descriptive purposes only.

What is claimed is the following:

1. A self watering system for plant displays, wherein said system comprises:
a display support structure;
a top on said display support structure;
said top having side panels and a bottom having a water tight connection;
a reservoir placed in said top between said side panels;
said reservoir capable of supporting plants without submersing said plants in water;
a water supply for providing water in said reservoir and said perforations; and
a capillary mat placed on top of said reservoir.

2. The system of claim 1 wherein said reservoir includes:
a plurality of perforations forming a honeycomb material for containing water.

3. The system of claim I wherein said reservoir includes:
a thickness sufficient to prevent said capillary mat from being submersed in the water.

4. The system of claim 1 wherein said capillary mat includes:
a material for the plants to sit upon while wicking water from said reservoir to the root structure of the plants.

5. The system of claim 1 wherein said capillary mat includes:
a material formed from a woven barrier fabric for the plants to sit upon while wicking water from said reservoir to the root structure of the plants.

6. The system of claim 1 wherein said water supply includes:
at least one water supply pipe extending along one side of said top and having a series of spaced perforations for providing water evenly to said reservoir.

7. The system of claim 1 wherein said system includes:
at least one stand pipe for allowing said top to drain to prevent overfilling.

8. A self watering system for plant displays, wherein said system comprises:
a display support structure;
a top on said display support structure;
said top having side panels and a bottom having a water tight connection;
a reservoir having a series of perforations for holding water placed in said top between said side panels;
said reservoir capable of supporting plants without submersing said plants in water;
at least one water supply pipe extending along one side of said top for providing water in said reservoir and said perforations; and
a capillary mat placed on top of said reservoir.

9. The system of claim 8 wherein said reservoir includes:
a thickness sufficient to prevent said capillary mat from being submersed in the water.

10. The system of claim 8 wherein said capillary mat includes:
a material for the plants to sit upon while wicking water from said reservoir to the root structure of the plants.

11. The system of claim 8 wherein said capillary mat includes:
a material formed from a woven barrier fabric for the plants to sit upon while wicking water from said reservoir to the root structure of the plants.

12. The system of claim 8 wherein said water supply includes:
said at least one water supply pipe having a series of spaced perforations for providing water evenly to said reservoir.

13. The system of claim 8 wherein said system includes:
at least one stand pipe for allowing said top to drain to prevent overfilling.

14. A method for self watering of plants on a display structure having a top with side panels and a bottom, said method includes:
providing a reservoir on said bottom capable of supporting the plants;
providing a water supply to provide water to said reservoir;
providing a capillary mat on top of said reservoir for supporting the plants and for absorbing water from said reservoir until said capillary mat is saturated; wherein the roots of the plants absorb water from said saturated capillary mat.

15. The method of claim 14 wherein said step of providing said reservoir includes:
providing a plurality of perforations in said reservoir to contain water.

16. The method of claim 14 wherein said step of providing said water supply includes:
providing a water supply pipe along one side of said top having a plurality of perforations for providing water evenly across said reservoir.

17. The method of claim 14 wherein said step of providing a capillary mat includes:
providing a mat formed form a woven barrier fabric that plants may sit upon.
